(19) United States
(12) Patent Application Publication
(10) Pub. No.: US 2011/0222894 A1
(43) Pub. Date: Sep. 15, 2011

(54) FIXING DEVICE AND IMAGE FORMING APPARATUS

(75) Inventors: Naoki YAMAMOTO, Toyohashi-shi (JP); Mamoru Fukaya, Nagoya-shi (JP); Noboru Yonekawa, Toyohashi-shi (JP); Toru Hayase, Toyohashi-shi (JP)

(73) Assignee: Konica Minolta Business Technologies, Inc., Chiyoda-ku (JP)

(21) Appl. No.: 13/024,464

(22) Filed: Feb. 10, 2011

(30) Foreign Application Priority Data
Mar. 11, 2010 (JP) 2010-054054

(51) Int. Cl. G03G 15/20

(52) U.S. Cl. 399/88; 399/329

(57) ABSTRACT

A fixing device for fixing a toner image onto a recording sheet, the fixing device comprising: a fixing belt including, on an inner circumference side thereof, a resistance heating layer, extending over entire circumference of the fixing belt, operable to emit heat upon flowing of an electric current therethrough; a pressing member operable to press an outer circumference of the fixing belt to form a fixing nip therebetween so that, while the recording sheet passes through the fixing nip, the toner image is fixed onto the recording sheet; and a pair of power supply members arranged inside the fixing belt along the circumferential direction with a predetermined distance therebetween, the power supply members being in contact with the inner circumferential surface of the resistance heating layer in an electrically conductive state along a direction perpendicular to the circumferential direction.

This application is based on an application No. 2010-054054 filed in Japan, the contents of which are hereby incorporated by reference.

### BACKGROUND OF THE INVENTION

(1) Field of the Invention

The present invention relates to a fixing device for fixing an unfixed image formed on a recording sheet onto the recording sheet by heating thereof, and to an image forming apparatus provided with the fixing device.

(2) Description of the Related Art

In image forming apparatuses such as printers or copiers adopting the electrophotographic method, typically a toner image corresponding to a piece of image data is transferred onto a recording paper sheet or a recording sheet such as an OHP sheet, and the unfixed toner image is then fixed onto the recording sheet by the fixing device. The fixing device fixes a toner image onto a recording sheet by heating the toner image and pressing it against the recording sheet.

As the structure of such fixing device for image forming apparatuses, a structure using a heating fixing belt is known, the heating fixing belt being provided with a resistance heating layer that emits heat as the current flows. For example, Patent Literature 1 (Japanese Patent Application Publication No. 2004-281123) discloses a fixing device in which a pressing roller is pressed against a heating belt (the heating fixing belt) provided with the resistance heating layer. In this fixing device, while the heating belt in the heating state moves in a circling motion, the recording sheet is pressed against the heating belt by the pressing roller, which enables the toner image to be heated and fixed onto the recording sheet.

The resistance heating layer provided in the heating belt is typically made of an insulation material in which an electrically conductive material is added so that the resistance heating layer has a predetermined electric resistivity, wherein the insulation material is, for example, an insulation ceramic or a heat-resistant resin, and the electrically conductive material is, for example, an electrically conductive ceramic, an electrically conductive carbon, or metal powder. The heating belt is provided with power supply terminals at both sides thereof in the width direction, and the surfaces of the power supply terminals on the inner circumference side of the belt are exposed. Power is supplied to between the two power supply terminals when the power supply terminals are in contact with roll or bar electrodes. This causes the resistance heating layer to be heated.

Also, Patent Literature 2 (Japanese Patent Application Publication No. 2007-272223) discloses a fixing device provided with a heating fixing belt and a pressing roll, the heating fixing belt including a heating layer. In this fixing device, a belt holder is provided in a circling motion area of the heating fixing belt, the belt holder includes two electrodes which face side edge portions of both sides of the heating layer in the width direction, and the respective electrodes are caused to be in sliding contact with the side edge portions of both sides of the heating layer.

Furthermore, Patent Literature 3 (Japanese Patent Application Publication No. H6-348155) discloses a fixing device in which a fixing nip is formed between a heating medium and a pressing elastic roller that are pressed against each other, wherein the heating medium is in a sleeve or belt shape and is composed of: an electrically conductive supporting layer; and a heating layer stacked on the supporting layer. The fixing device includes a roll or bar electrode provided in parallel with the rotational axis of the heating medium, and the electrode and the heating layer are brought into contact with each other, which causes the electric current to flow between the electrode and the electrically conductive supporting layer, thereby heating the heating layer.

### Problems to be Solved by the Invention

In the fixing devices disclosed in Patent Literatures 1 and 2, the electric current flows through the heating layer provided in the heating fixing belt which moves in a circling motion, along the width direction of the belt (in the direction along the rotation axis) perpendicular to the direction of the circling motion. This causes the heating layer having a predetermined electric resistivity to be heated.

In that case, in the heating layer, the electric current diffuses from a power supply terminal at one side edge portion of the belt that is in contact with the electrode, and the electric current converges at a power supply terminal at the other side edge portion of the belt. Due to this, the current density and thus the temperature is locally higher in the vicinity of each power supply terminal. As a result, the heating layer is not heated uniformly in temperature distribution in the width direction of the belt, and there is a fear that the recording sheet moving together with the heating fixing belt moving in a circling motion may not be heated uniformly in the width direction of the belt.

Also, in the fixing device of Patent Literature 1, the power supply terminals are formed by removing the inner circumference side portions from both sides of the heating belt in the width direction thereof over the whole part in the circumferential direction of the belt and attaching the power supply terminals in place of the removed portions to be exposed to the space surrounded by the belt. Thus the heating belt is thinner and therefore weaker at both sides in the width direction than the center thereof. Accordingly, when the stress concentrates on each side edge portion of the heating belt, there is a fear that the heating layer may be broken in the vicinity of the power supply terminal.

In the fixing device disclosed in Patent Literature 3, the electric current is flown in the thickness direction of the heating layer from the electrode which is in contact with the outer circumferential surface of the heating layer along the width direction (the rotation axis direction), by stacking the electrically conductive supporting layer to cover the whole inner circumferential surface of the heating layer. In this case, it is necessary to stack the electrically conductive supporting layer to cover the whole inner circumferential surface of the heating layer. Due to this, the heating medium becomes thick all over thereof and the entire thermal capacity becomes large. The technology thus has problems that a lot of power is required to heat the heating medium and the warming-up time becomes longer.

Note that there is also known a technology in which the power supply terminals are formed by removing the outer circumference surface portions (portions to be in contact with the recording sheet) from both sides of the heating belt in the width direction thereof so that the heating layer is exposed. In this case, however, there is a fear that toner or sheet powder having removed from the recording sheet having contacted with the outer circumferential surface of the heating belt is attached to the power supply terminals. When sheet powder or the like is attached to the power supply terminals, the state of power supply to the heating layer becomes unstable and the heating layer may fail to be heated to the predetermined temperature. This prevents the toner image from being heated sufficiently, preventing the toner from being fixed appropriately.

### SUMMARY OF THE INVENTION

It is therefore an object of the present invention to provide a fixing device for heating a resistance heating layer which is provided in a fixing belt that moves in a circling motion, uniformly along the direction perpendicular to the circumferential direction, thereby improving the heating efficiency and durability. Also, it is another object of the present invention to provide an image forming apparatus including the fixing device.

### Means for Solving the Problems

The above object is fulfilled by a fixing device for fixing a toner image onto a recording sheet, the fixing device comprising: a fixing belt including, on an inner circumference side thereof, a resistance heating layer, extending over entire circumference of the fixing belt, operable to emit heat upon flowing of an electric current therethrough; a pressing member operable to press an outer circumference of the fixing belt to form a fixing nip therebetween so that, while the recording sheet passes through the fixing nip, the toner image is fixed onto the recording sheet; and a pair of power supply members arranged inside the fixing belt along the circumferential direction with a predetermined distance therebetween, the power supply members being in contact with the inner circumferential surface of the resistance heating layer in an electrically conductive state along a direction perpendicular to the circumferential direction.

Said another object is fulfilled by an image forming apparatus including the fixing device.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a schematic view showing the structure of a tandem type intermediate transfer color laser printer, which is an example of the image forming apparatus pertaining to an embodiment of the present invention;

FIG. 2 is a cross-sectional schematic view showing the structure of the main parts of the fixing device provided in the printer;

FIG. 3A is a development plan view showing a part of the inner circumferential surface of the fixing belt provided in the fixing device; FIG. 3B is a cross-sectional view taken along line E-E of FIG. 2;

FIG. 4 is a cross-sectional schematic view showing the structure of the main parts of the fixing device in another embodiment of the present invention; and

FIG. 5 is a cross-sectional schematic view showing the structure of the main parts of the fixing device in further another embodiment of the present invention.

### DESCRIPTION OF THE PREFERRED EMBODIMENTS

The following describes a fixing device and an image forming apparatus in embodiments pertaining to the present invention.

### Embodiment 1

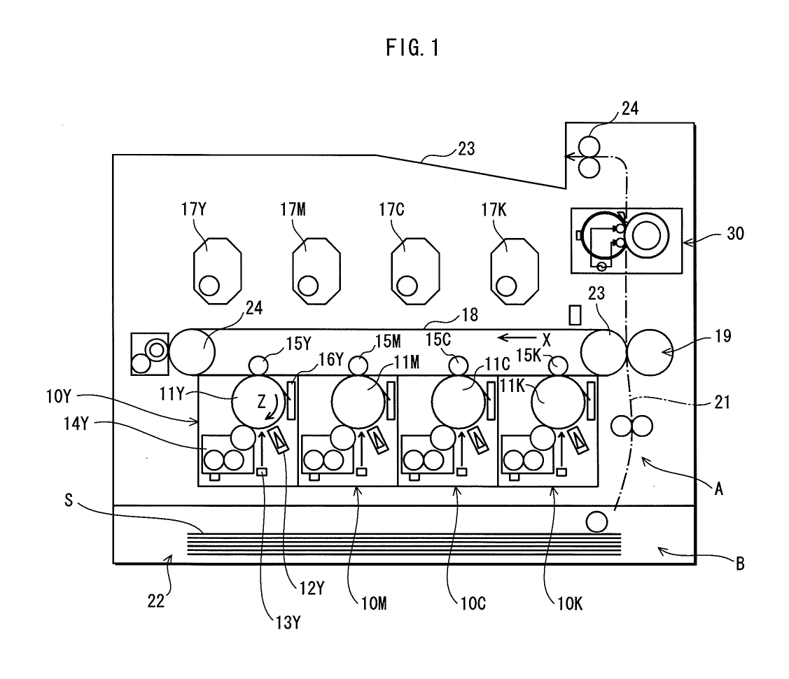

FIG. 1 is a schematic view showing the structure of a tandem type color printer (hereinafter merely referred to as a “printer”), which is an example of the image forming apparatus provided with the fixing device pertaining to an embodiment of the present invention. This color printer forms a full-color or monochrome image onto a recording paper sheet or a recording sheet such as an OHP sheet by a known electrophotographic method based on image data or the like input from an external terminal device or the like via a network (for example, LAN).

The printer includes an image forming section A and a paper feed section B which is located below the image forming section A, wherein the image forming section A forms a toner image with toners of colors yellow (Y), magenta (M), cyan (C), and black (K) onto a recording sheet. The paper feed section B includes a paper feed cassette 22 storing inside therein recording sheets S, and the recording sheets S stored in the paper feed cassette 22 are fed to the image forming section A.

The image forming section A includes an intermediate transfer belt 18 which is provided at an approximate center of the printer. The intermediate transfer belt 18 is wound around a pair of belt tensioning rollers 23 and 24 which are arranged with a horizontal distance therebetween so that the belt can move, circling around the belt tensioning rollers. The intermediate transfer belt 18 is driven by a motor (not illustrated) to move in the direction indicated by the arrow “X”.

Process units 10Y, 10M, 10C, and 10K are provided below the intermediate transfer belt 18. Process units 10Y, 10M, 10C, and 10K are disposed in the stated order in the direction in which the intermediate transfer belt 18 moves in a circling motion, and form toner images with toners of colors yellow (Y), magenta (M), cyan (C), and black (K) onto the intermediate transfer belt 18, respectively. Each of the process units 10Y, 10M, 10C, and 10K is attachable and detachable to/from the image forming section A.

Above the intermediate transfer belt 18, toner containers 17Y, 17M, 17C, and 17K are disposed to face the process units 10Y, 10M, 10C, and 10K respectively via the intermediate transfer belt 18. The toner containers 17Y, 17M, 17C, and 17K respectively contain toners of colors yellow (Y), magenta (M), cyan (C), and black (K), which are supplied to the process units 10Y, 10M, 10C, and 10K, respectively.

The process units 10Y, 10M, 10C, and 10K have substantially the same structure except that they use toners of different colors that are supplied from the toner containers 17Y, 17M, 17C, and 17K, respectively. Thus in the following, only the structure of the process unit 10Y is explained, and description of the structures of the other process units 10M, 10C, and 10K is omitted.

The process unit 10Y includes a photosensitive drum 11Y which is disposed under the intermediate transfer belt 18 to be able to rotate facing the intermediate transfer belt 18. The photosensitive drum 11Y can rotate in the direction indicated by the arrow “Z”. The process unit 10Y includes a charger 12Y which is disposed below the photosensitive drum 11Y and electrically charges the surface of the photosensitive drum 11Y evenly. The charger 12Y is disposed to face the photosensitive drum 11Y.

The process unit 10Y further includes an exposure device 13Y and a developing unit 14Y. The exposure device 13Y is disposed in the downstream of the charger 12Y in the rotation direction of the photosensitive drum 11Y, below the photosensitive drum 11Y in the vertical direction. The developing unit 14Y is disposed in the downstream of an exposure position, exposed by the exposure device 13Y, on the surface of the photosensitive drum 11Y in the rotation direction of the photosensitive drum 11Y.

The exposure device 13Y radiates a laser beam L onto the surface of the photosensitive drum 11Y, which has been electrically charged by the charger 12Y evenly, to form an electrostatic latent image thereon. The developing unit 14Y develops the electrostatic latent image formed on the surface of the photosensitive drum 11Y, with use of the toner of color Y.

Above the process unit 10Y, a first transfer roller 15Y is disposed to face the photosensitive drum 11Y via the intermediate transfer belt 18. The first transfer roller 15Y is attached to the image forming section A. Upon receiving application of a transfer bias voltage, the first transfer roller 15Y forms an electric field between the roller itself and the photosensitive drum 11Y.

Note that first transfer rollers 15M, 15C, and 15K are disposed as well above the process units 10M, 10C, and 10K to face the photosensitive drums 11M, 11C, and 11K via the intermediate transfer belt 18, respectively.

The toner images formed on the photosensitive drums 11Y, 11M, 11C, and 11K are transferred onto the intermediate transfer belt 18 as the first transfer, by the action of the electric fields formed between the first transfer rollers 15Y, 15M, 15C, and 15K and the photosensitive drums 11Y, 11M, 11C, and 11K, respectively.

Note that, when a full-color image is to be formed, the timings at which the process units 10Y, 10M, 10C, and 10K form the respective images are adjusted so that, by the multi-transfer, the toner images are transferred from the photosensitive drums 11Y, 11M, 11C, and 11K to the same area on the surface of the intermediate transfer belt 18.

On the other hand, when a monochrome image is to be formed, only a selected process unit (for example, the process unit 10K that uses the toner of color K) is driven so that a toner image is formed on the photosensitive drum corresponding to the process unit (for example, the photosensitive drum 11K) and transferred therefrom to a predetermined area on the surface of intermediate transfer belt 18 by the first transfer roller 15K.

Note that the process unit 10Y includes a cleaning member 16Y for cleaning the photosensitive drum 11Y on which the toner image has been transferred.

A second transfer roller 19 is disposed at a location to face, via a sheet transport route 21, an end (shown on the right-hand side of FIG. 1) of the intermediate transfer belt 18 which is located in the downstream in the direction in which the toner images thereon are transported. The second transfer roller 19 is pressed against the intermediate transfer belt 18 so that a transfer nip is formed therebetween. The transfer bias voltage is applied to the second transfer roller 19 so that an electric field is formed between the second transfer roller 19 and the intermediate transfer belt 18.

A recording sheet S is sent on the sheet transport route 21 from the paper feed cassette 22 of the paper feed section B, and fed into the transfer nip formed by the second transfer roller 19 and the intermediate transfer belt 18. By the action of the electric field formed between the second transfer roller 19 and the intermediate transfer belt 18, the toner image, having been transferred onto the intermediate transfer belt 18, is transferred therefrom onto the recording sheet S, which is transported on the sheet transport route 21, as the second transfer.

The recording sheet S having passed through the transfer nip is transported to the fixing device 30 placed above the second transfer roller 19. In the fixing device 30, the unfixed toner image on the recording sheet S is heated and pressed to be fixed on the recording sheet S. The recording sheet S with the toner image fixed thereon is ejected by a paper-eject roller 24 onto a paper tray 23 disposed above the toner containers 17Y, 17M, 17C, and 17K.

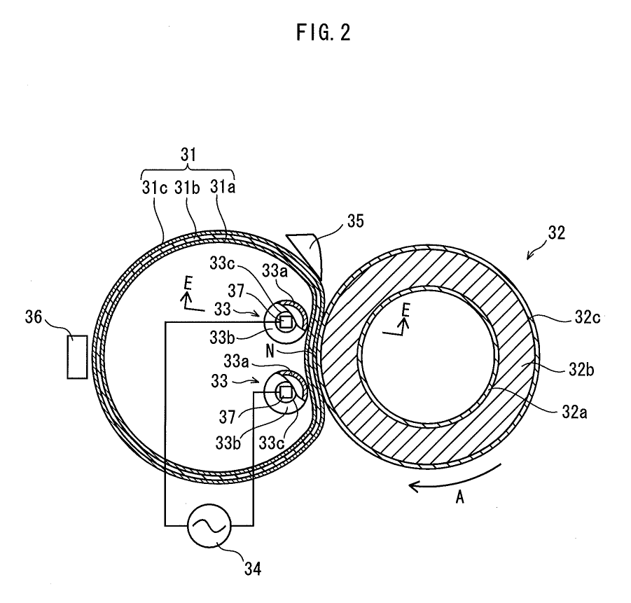

FIG. 2 is a cross-sectional schematic view showing the structure of the main parts of the fixing device 30. The fixing device 30 includes a pressing roller 32, a fixing belt 31, and a pair of power supply rollers 33. The pressing roller 32 applies a pressure. The fixing belt 31 is arranged so that it can move in a circling motion in the state where it is pressed by the pressing roller 32. The power supply rollers 33 press the fixing belt 31 from the inside of the belt toward the pressing roller 32. Note that, in FIG. 2, the power supply rollers 33 are shown in a partially cut away side view, not in a cross-sectional view. The fixing belt 31 is heated when it receives supply of power from the pair of power supply rollers 33.

The fixing belt 31 is substantially equal with the pressing roller 32 in diameter. Also, the width of the fixing belt 31, the length of the outer circumferential surface of the fixing belt 31 along the axis direction thereof (a direction perpendicular to the circumferential direction) is substantially equal with the length of the outer circumferential surface of the pressing roller 32 along the axis direction thereof. The fixing belt 31 and the pressing roller 32 are arranged so that a part of the outer circumferential surface of the fixing belt 31 is pressed against a part of the outer circumferential surface of the pressing roller 32 in the state where the axes of them are parallel to each other.

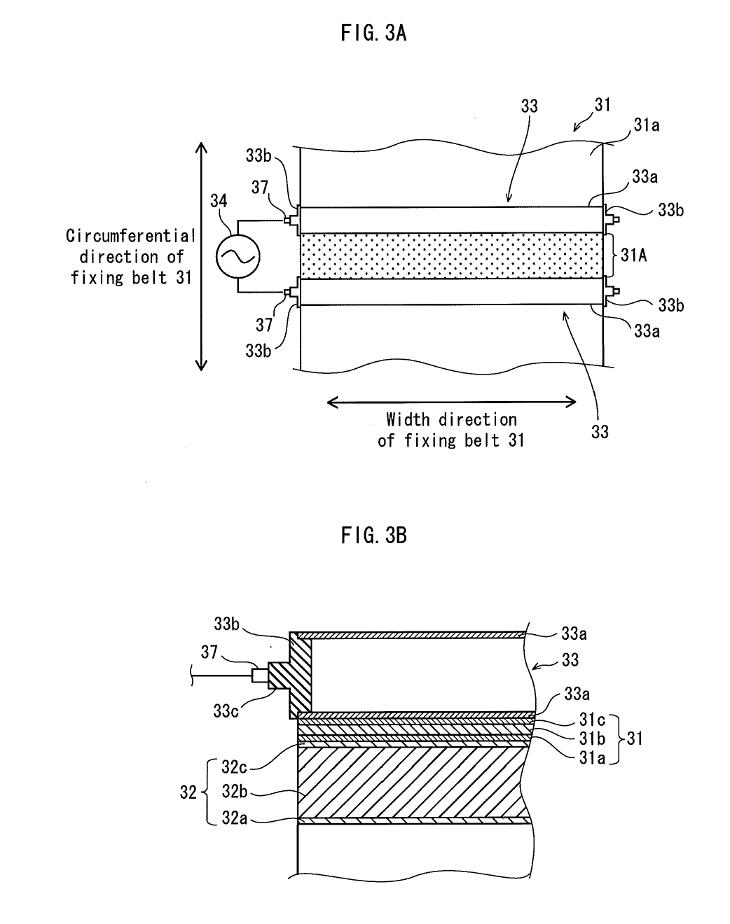

FIG. 3A is a development view showing a part of the inner circumferential surface of the fixing belt 31 against which the pair of power supply rollers 33 are pressed. FIG. 3B is a cross-sectional view taken along line E-E of FIG. 2. Each of the pair of power supply rollers 33, which are provided inside the circling motion area of the fixing belt 31, includes a roller body 33a and two electrically conductive axial members 33b. The roller body 33a has a cylindrical shape and its diameter is smaller than that of the pressing roller 32. The two axial members 33b are fit into respective ends of the roller body 33a. The whole outer circumferential surface of the roller body 33a is electrically conductive. The axial members 33b are fit into the roller body 33a to be one unit, and are electrically connected with the outer circumference of the roller body 33a. Each of the axial members 33b is provided with, as part thereof, an axial projection 33c which projects outside from the roller body 33a along the axis of the roller body 33a.

The two roller bodies 33a, extending along the width direction of the fixing belt 31, are arranged inside the fixing belt 31 in parallel with each other, facing the outer circumferential surface of the pressing roller 32 via the fixing belt 31. As shown in FIG. 2, the two roller bodies 33a are arranged in parallel in the vertical direction with a predetermined distance therebetween.

Each of the axial projections 33c of the axial members 33b provided at both ends of each power supply roller 33 is supported, in a rotatable state, by a housing (not illustrated) of the fixing device 30 in the state where the axial projections 33c is urged toward the pressing roller 32 by an urging means (such as a pull spring) (not illustrated). Note that each axial projection 33c and the housing of the fixing device 30 are insulated from each other.

The roller body 33a of each power supply roller 33, extending along the width direction perpendicular to the circumferential direction, is pressed against the inner circumferential surface of the fixing belt 31 by the urging force provided by the urging means. In the present embodiment, the roller bodies 33a of the power supply rollers 33 are arranged with a predetermined distance therebetween along the circumferential direction so that the outer circumferential surface of the fixing belt 31 is pressed against the outer circumferential surface of the pressing roller 32 in the range defined by approximately 30 degrees of the central angle of the pressing roller 32.

The roller bodies 33a of the power supply rollers 33 are pressed against the inner circumferential surface of the fixing belt 31 so that they press the outer circumferential surface of the fixing belt 31 against the outer circumferential surface of the pressing roller 32. With this structure, the circumference of the fixing belt 31 is dented between the two power supply rollers 33 along the outer circumferential surface of the pressing roller 32, and a fixing nip N, through which the recording sheet S is to pass, is formed between the fixing belt 31 and the pressing roller 32.

Note that a paper separating claw 35 is disposed in the downstream of the fixing nip N in the moving direction of the fixing belt 31, wherein the paper separating claw 35 separates the recording sheet S having passed through the fixing nip N from the fixing belt 31.

The pressing roller 32 is driven by a motor (not illustrated) to rotate in the direction indicated by the arrow “A”. The fixing belt 31 is pressed against the outer circumferential surface of the pressing roller 32 by the roller bodies 33a of the pair of power supply rollers 33, and moves following the rotation of the pressing roller 32. The power supply rollers 33 pressed against the inner circumferential surface of the fixing belt 31 rotate following the movement of the fixing belt 31.

The fixing belt 31 includes, for example, three layers: a resistance heating layer 31a disposed on the inner circumference side; an elastic layer 31b stacked on the outer circumference side of the resistance heating layer 31a; and a releasing layer 31c stacked on the outer circumference side of the elastic layer 31b. The resistance heating layer 31a on the inner circumference side has an electric resistivity that is almost constant all over the whole circumference, and emits Joule heat when the current flows therein. The elastic layer 31b has a predetermined elasticity so that the fixing belt 31 is elastically pressed against the outer circumferential surface of the pressing roller 32. The releasing layer 31c has the releasability with which the recording sheet S, having been pressed against the surface of the layer itself in the fixing nip N, is easily released therefrom.

Each of the resistance heating layer 31a, elastic layer 31b, and releasing layer 31c has a constant thickness. The fixing belt 31, composed of the three layers: resistance heating layer 31a: elastic layer 31b; and releasing layer 31c, has predetermined hardness, and maintains a cylindrical shape with a predetermined diameter when it is not pressed against the pressing roller 32, and deforms to have an arc dent along the outer circumferential surface of the pressing roller 32 when it is pressed against the pressing roller 32.

The length of the roller bodies 33a of the power supply rollers 33 along the axis thereof is substantially the same as the width of the fixing belt 31. The power supply rollers 33 are pressed against the resistance heating layer 31a which is an inner circumferential layer of the fixing belt 31. With this structure, the outer circumferential surface of the power supply rollers 33 are in contact with the inner circumferential surface of the resistance heating layer 31a in the electrically conductive state.

As shown in FIG. 3B, an electrode member 37 is, by pressurizing, brought into contact with the axial projection 33c of the axial member 33b provided in one end of each power supply roller 33. Each electrode member 37 is in contact with the axial projection 33c of the axial member 33b to be electrically conductive with the axial projection 33c. Each electrode member 37 becomes in sliding contact with the axial projection 33c of the axial member 33b when the corresponding power supply rollers 33 rotates, maintaining the state of being electrically conductive with the axial projection 33c. In the present embodiment, an electrically conductive brush, which is formed by baking a mixture of powders of carbon, copper or the like, is used as the electrode member 37.

The alternating current is supplied to each electrode member 37 from an alternating current power 34. The electric current supplied from the alternating current power 34 to one electrode member 37 is supplied to the resistance heating layer 31a of the fixing belt 31 via one power supply roller 33 which is in contact with the electrode member 37, passes through an area 31A (see FIG. 3A) of the resistance heating layer 31a forming the fixing nip N between the power supply rollers 33, and then is supplied to the other electrode member 37 via the other power supply roller 33.

The resistance heating layer 31a of the fixing belt 31 which moves in a circling motion is heated by the electric current that flows in the area 31A positioned between the two power supply rollers 33. In that case, since each of the pair of power supply rollers 33 is arranged along the width direction of the resistance heating layer 31a, the electric current supplied to the whole part in the axis direction of one of the power supply rollers 33 flows along the circumferential direction of the area 31A of the resistance heating layer 31a, and is supplied to the whole part in the axis direction of the other of the power supply rollers 33.

With this structure, the resistance heating layer 31a emits Joule heat that is approximately uniform over the whole part in the width direction in the area 31A positioned between the power supply rollers 33. The resistance heating layer 31a is heated over the whole thereof when the area 31A of the resistance heating layer 31a continues to move in the circling motion while emitting the heat.

Temperature is detected from the outer circumferential surface of the fixing belt 31 moving in the circling motion, by a temperature sensor 36 deposited on the other side of the circumference of the fixing belt 31 to face the outer circumferential surface of the fixing belt 31. The temperature detected from the outer circumferential surface of the fixing belt 31 by the temperature sensor 36 is used to control the alternating current supplied from the alternating current power 34. The alternating current supplied from the alternating current power 34 is controlled so that the outer circumferential surface of the fixing belt 31 has a predetermined fixing temperature.

When the recording sheet S passes through the fixing nip N in the state where the control is being performed so that the outer circumferential surface of the fixing belt 31 has the predetermined fixing temperature, the recording sheet S is heated approximately uniformly over the whole area thereof in the direction perpendicular to the transport direction, by the fixing belt 31 whose outer circumferential surface has been heated to the predetermined fixing temperature approximately uniformly over the whole part in the width direction of the belt by the heating of the resistance heating layer 31a. In the fixing nip N, the recording sheet S is pressed at both sides by the fixing belt 31 and the pressing roller 32 that are pressed against each other. This causes the unfixed toner image to be fixed onto the recording sheet S.

The recording sheet S on which the toner image has been fixed in the fixing nip N is then separated from the fixing belt 31 by the paper separating claw 35, transported to a paper-eject roller 24 shown in FIG. 1, and ejected onto a paper tray 23 by the paper-eject roller 24.

The resistance heating layer 31a of the fixing belt 31 is made of an insulation material in which an electrically conductive filler (additive) is dispersed uniformly so that the resistance heating layer 31a has a predetermined electric resistivity all over the whole circumference of the belt. As the insulation material, a heat-resistant insulation resin, such as PI (polyimide), PPS (polyphenylenesulfide), or PEEK (polyether ether ketone), an insulation ceramic and the like are used suitably.

The electrically conductive filler is made of a metal, such as Ag, Cu, Al, Mg, or Ni, or a carbon-based material, such as a carbon nanotube, a carbon nanofiber or a carbon micro coil, and is in the form of fiber (filament), grains, or flakes. The amount of the electrically conductive filler in the insulation material is adjusted so that the resistance heating layer 31a has a predetermined electric resistivity over the whole thereof.

Note that the electrically conductive filler is preferably in the form of fiber. When the electrically conductive filler is in the form of fiber, the filler can be arranged easily so that portions thereof are in contact with one another. This makes it easy to adjust the resistance heating layer 31a to have a predetermined electric resistivity over the whole thereof.

Not limited to the structure where one type of electrically conductive filler having a predetermined electric resistivity is dispersed in the insulation material, two types of electrically conductive fillers having different electric resistivity may be dispersed in the insulation material so that, with use of it, the resistance heating layer 31a has a predetermined electric resistivity over the whole thereof.

The resistance heating layer 31a is not limited to a specific thickness in particular, but the thickness is typically in the range from 5 μm to 100 μm approximately.

The electric resistivity of the resistance heating layer 31a is not limited to a specific value, but may be set to an appropriate value based on the power supplied to the resistance heating layer 31a, the thickness, the length in the circumferential direction, toner properties of the resistance heating layer 31a and the like. The electric resistivity of the resistance heating layer 31a is typically in the range from 1.0×10⁻⁶ Ω·m to 9.9×10⁻³ Ω·m approximately, and preferably in the range from 1.0×10⁻⁵ Ω·m to 5.0×10⁻³ Ω·m approximately.

The elastic layer 31b stacked on the outer circumferential surface of the resistance heating layer 31a is made of an elastic material such as a highly heat-resistant Si (silicon) rubber or a fluorine containing rubber. In the present embodiment, a Si rubber is used as the elastic layer 31b.

The releasing layer 31c stacked on the outer circumferential surface of the elastic layer 31b has releasability on toner so that the recording sheet S, having been pressed against the surface of the layer itself in the fixing nip N, can be easily released from it. The releasing layer 31c has typically 90 degrees or more of, and preferably 110 degrees or more of contact angle with water, and its surface roughness “Ra” is preferably in the range from 0.01 μm to 50 μm approximately. Note that the releasing layer 31c may be electrically conductive.

The releasing layer 31c is formed from a fluorine-based tube or a fluorine-based coating, such as PFA (copolymer of tetrafluoroethylene and perfluoroalkoxyethylene), PTFE (polytetrafluoroethylene resin), ETFE (copolymer of ethylene and tetrafluoroethylene), to have, for example, a thickness in the range from 5 μm to 100 μm approximately. As the fluorine-based tube, “PFA350-J”, “451HP-J”, and “951HP Plus” which are products made by Du Pont-Mitsui Fluorochemicals Company, LTD. and the like are suitable.

Note that the fixing belt 31 is not limited to the three-layer structure composed of the resistance heating layer 31a, elastic layer 31b, and releasing layer 31c, but may include four or more layers by additionally stacking a reinforcement layer made of a resin such as PI or PPS, an insulating layer or the like. Also, in the case of a printer that forms monochrome images, the fixing belt 31 may have a two-layer structure composed of the resistance heating layer 31a and the releasing layer 31c, without the elastic layer 31b. In either case, the resistance heating layer 31a needs to be arranged on the most inner circumferential side so as to be able to receive the power supply.

As shown in FIGS. 2 and 3B, the pressing roller 32 is formed by stacking, on the outer circumferential surface of a pipe-shaped cored bar 32a, an elastic layer 32b and a releasing layer 32c in the stated order. The pressing roller 32 is in a cylindrical shape, with the outer diameter being in the range from 20 mm to 100 mm approximately. The cored bar 32a is, for example, a metal pipe made of aluminum or iron, with the thickness being in the range from 0.1 mm to 10 mm approximately.

The elastic layer 32b is made of a highly heat-resistant elastic material such as a silicon rubber or a fluorine rubber, with the thickness being in the range from 1 mm to 20 mm approximately.

The releasing layer 32c of the pressing roller 32 is formed from a material having the releasability, such as a fluorine tube or a fluorine coating, to a thickness in the range from 5 μm to 100 μm approximately. The releasing layer 32c may be electrically conductive.

Note that the cored bar 32a is not limited to the pipe shape, but may be in the form of a solid cylinder. Also, the cross-sectional view of the cored bar 32a is not limited to a circle, but may have three or more projections projecting outward and provided at regular intervals in the circumferential direction, for holding the elastic layer 32b in the cylindrical shape which is fitted on the outer side thereof.

The roller body 33a of each power supply roller 33 is typically formed from a metal such as Cu, Al, brass, or phosphor bronze. Note that the roller body 33a is not limited to being formed from a metal, but may be a cylindrical body whose outer circumferential surface is made of an insulating material such as ceramic or synthetic resin, and stacked with a plated layer of an electrically conductive metal such as Cu, Ni, or brass. In the case of this structure, the outer surface of the axial member 33b at one end of the roller body 33a and the outer circumferential surface of the roller body 33a may be plated as one unit so that the axial member 33b and the roller body 33a are rendered electrically conductive with each other.

In the fixing device 30 of the present embodiment, the resistance heating layer 31a of the fixing belt 31 is heated uniformly over the whole length in the width direction thereof, and thus the recording sheet S passing through the fixing nip N is heated approximately uniformly over the whole area thereof in the width direction perpendicular to the transport direction. This enables the toner image on the recording sheet S to be heated approximately uniformly along the width direction of the recording sheet S when it is fixed on the recording sheet S. As a result, there is no unevenness caused by heating on the toner image fixed on the recording sheet S, making it possible to obtain a high-quality toner image.

Also, the resistance heating layer 31a of the fixing belt 31 is arranged on the most inner circumferential side of the fixing belt 31 and is pressed against the pair of power supply rollers 33 which supply the current to the resistance heating layer 31a. With this structure, there is no fear that toner or sheet powder having removed from the recording sheet having contacted with the outer circumferential surface of the fixing belt 31 is attached to the power supply unit which is composed of the resistance heating layer 31a and the pair of power supply rollers 33 pressed against each other. As a result, there is no fear that the power supply state of each power supply unit becomes unstable, and it is possible to supply power stably to the resistance heating layer 31a.

Furthermore, the resistance heating layer 31a constituting the inner circumferential surface of the fixing belt 31 has constant width and thickness over the whole area thereof, and the fixing belt 31 has a structure in which the width is constant and the thickness is uniform over the whole area thereof. Accordingly there is no fear that the fixing belt 31 is locally reduced in strength and, due to this, the durability of the fixing belt 31 is lowered. As a result, it is possible to use the fixing belt 31 stably for a long time.

In the present embodiment, the outer circumferential surface of the roller body 33a of each power supply roller 33 becomes in contact with approximately the whole area of the fixing belt 31 in the width direction thereof. However, not limited to this structure, the outer circumferential surface of the roller body 33a may become in contact with at least an area of the inner circumferential surface of the fixing belt 31 whose length in the width direction corresponds to the area of the fixing nip N through which the recording sheet S passes.

Also, in the present embodiment, the power supply rollers 33 rotate following the fixing belt 31. However, not limited to this structure, the power supply rollers 33 may not rotate. Also, in place of the power supply rollers 33, a power supply member having an arbitrary cross-sectional shape may be pressed against the resistance heating layer 31a of the fixing belt 31 along the width direction of the fixing belt 31 to be in sliding contact with the resistance heating layer 31a. In the case of this structure, the power supply member may be an electrically conductive brush.

Furthermore, in the present embodiment, the electrode member 37 is brought into contact with the axial projection 33c of the axial member 33b of the power supply roller 33 so that power is supplied to the outer circumferential surface of the roller body 33a. However, not limited to this structure, the electrode member 37 may be directly brought into contact with the outer circumferential surface of the roller body 33a that is not in contact with the fixing belt 31 so that power is supplied thereto.

### Embodiment 2

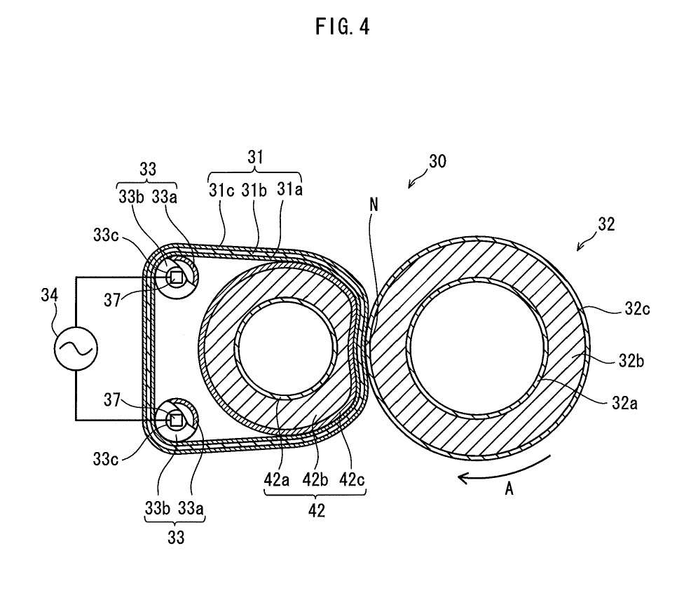

FIG. 4 is a cross-sectional schematic view showing the structure of the main parts of the fixing device 30 in Embodiment 2. The fixing device 30 in Embodiment 2 has the same structure as the fixing device 30 in Embodiment 1 except that the fixing belt 31 in Embodiment 1 is wound around the pair of power supply rollers 33 and a pressing contact roller 42 arranged to face the pressing roller 32 so that the belt can move and circle around the rollers.

The pressing roller 32 in Embodiment 2 is the same as the pressing roller 32 in Embodiment 1, and rotates in the direction indicated by the arrow A.

The pressing contact roller 42 arranged to face the pressing roller 32 across the fixing belt 31 presses the fixing belt 31 toward the pressing roller 32 to form the fixing nip N. The pressing contact roller 42, for example, like the pressing roller 32, is in a cylindrical shape and formed by stacking, on the outer circumferential surface of a pipe-shaped cored bar 42a, an elastic layer 42b and a releasing layer 42c in the stated order. The outer diameter of the pressing contact roller 42 is slightly smaller than the outer diameter of the pressing roller 32.

The elastic layer 42b of the pressing contact roller 42 is lower than the elastic layer 32b of the pressing roller 32 in elasticity. Other than this, the pressing contact roller 42 has the same structure as the pressing roller 32. The outer circumferential surface of the pressing contact roller 42 is deformed to be dented along the outer circumferential surface of the pressing roller 32 when it is pressed toward the outer circumferential surface of the pressing roller 32 via the fixing belt 31.

The pressing contact roller 42 is, for example, arranged with a predetermined distance from the pressing roller 32 in the horizontal direction so that the outer circumferential surface thereof is dented corresponding to a range of the outer circumferential surface of the pressing roller 32 that is defined by approximately 30 degrees of the central angle of the pressing roller 32. The fixing nip N is formed in an area in which the fixing belt 31 and the pressing contact roller 42 are pressed against each other.

Each of the pair of power supply rollers 33 around which the fixing belt 31 is wound has the same structure as the power supply roller 33 in Embodiment 1, and thus the outer circumferential surface of each roller body 33a is electrically conductive, and the electrode member 37 is, by pressurizing, brought into contact with the axial projection 33c of one axial member 33b.

Each roller body 33a of each of the power supply rollers 33 has a smaller diameter than the pressing contact roller 42. In order to give tension to the fixing belt 31 which is also wound around the pressing contact roller 42, the roller bodies 33a are pressed against the inner circumferential surface of the resistance heating layer 31a, the inner circumferential surface of the fixing belt 31, on the opposite side of the fixing belt 31 from the pressing contact roller 42 facing the pressing roller 32. The alternating current is supplied to each electrode member 37 from the alternating current power 34.

The power supply rollers 33 are arranged in parallel in the vertical direction with a predetermined distance therebetween in the circling motion direction of the fixing belt 31 and are arranged in parallel along the width direction of the fixing belt 31. As a result, the fixing belt 31 is wound around approximately ¼ of the outer circumferential surface of each power supply roller 33.

The fixing belt 31 is sandwiched by the pressing roller 32 and the pressing contact roller 42 in the fixing nip N, and thus moves in a circling motion following the pressing roller 32 which is driven to rotate in the direction indicated by the arrow A.

Note that the fixing belt 31 is not limited to the structure where it moves in a circling motion following the pressing roller 32 which is driven to rotate, but may be moved in a circling motion by driving the pressing contact roller 42, around which the fixing belt 31 is wound, to rotate, or by driving both the pressing roller 32 and the pressing contact roller 42 to rotate.

In the fixing device 30 in Embodiment 2, as in Embodiment 1, an area of the resistance heating layer 31a between the two power supply rollers 33, of the fixing belt 31 moving in a circling motion, emits heat as the current flows between the power supply rollers 33. In this case, since each of the power supply rollers 33 is arranged along the width direction of the resistance heating layer 31a, the whole current supplied to one power supply roller 33 along the width direction flows to the other power supply roller 33 along the circumferential direction of the resistance heating layer 31a. With this structure, the resistance heating layer 31a emits Joule heat that is approximately uniform over the whole part in the width direction in the area between the power supply rollers 33.

Accordingly, as the recording sheet S passes through the fixing nip N, the unfixed toner image on the recording sheet S is heated and pressed to be fixed onto the recording sheet S by the fixing belt 31 that has been heated approximately uniformly over the whole part in the width direction of the belt by the heating of the resistance heating layer 31a, and in addition the recording sheet S is pressed at both sides by the fixing belt 31 and the pressing roller 32 that are pressed against each other. The recording sheet S is heated approximately uniformly over the whole area thereof and the toner image is fixed onto the recording sheet S. As a result, there is no fear that an uneven toner image is fixed onto the recording sheet S, and a high-quality toner image can be obtained.

Also, since the fixing belt 31 is formed to be uniform over the whole part thereof, it can be used stably for a long time, with no fear that the fixing belt 31 is locally reduced in strength. Furthermore, the resistance heating layer 31a is provided on the inner circumferential surface side of the fixing belt 31, and the power supply rollers 33 are in contact with the inner circumferential surface of the resistance heating layer 31a. Therefore, there is no fear that toner or sheet powder having removed from the recording sheet is attached to the part where the resistance heating layer 31a is in contact with the power supply rollers 33, and there is no fear that a failure occurs in the power supply to the resistance heating layer 31a.

### Embodiment 3

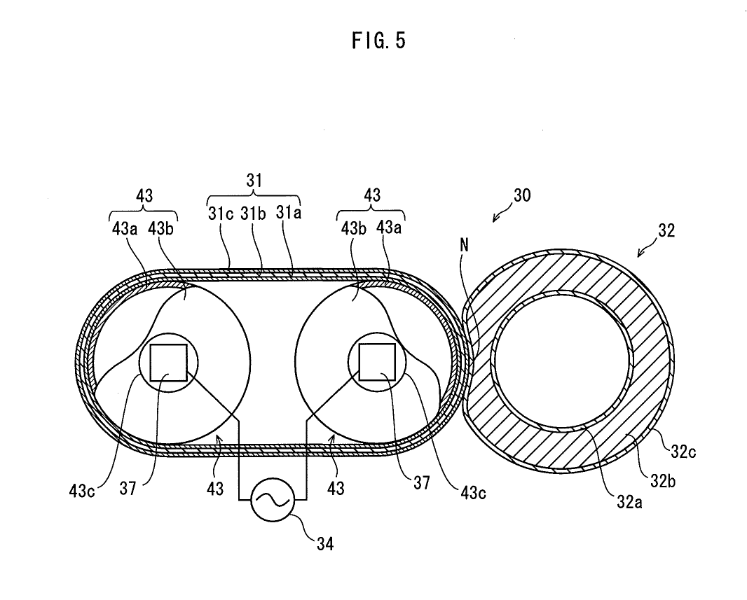

FIG. 5 is a cross-sectional schematic view showing the structure of the main parts of the fixing device 30 in Embodiment 3. The fixing device 30 in Embodiment 3 has the same structure as the fixing device 30 in Embodiment 2 shown in FIG. 4 except that the fixing belt 31 in Embodiment 1 is wound around a pair of power supply rollers 43 so that the belt can move and circle around the rollers, and that the electrode member 37 supplies power to the power supply rollers 43.

The fixing belt 31 in Embodiment 3 has the same structure as the fixing belt 31 of the fixing device 30 in Embodiment 2 except that they are different from each other in length in the circumferential direction. Accordingly, the fixing belt 31 has a three-layer structure composed of the resistance heating layer 31a, elastic layer 31b, and releasing layer 31c.

The power supply rollers 43 around which the fixing belt 31 is wound have the same structure as the power supply rollers 33 in Embodiment 2 except that the power supply rollers 43 each have approximately the same diameter as the pressing contact roller 42 in Embodiment 2. Accordingly, each of the power supply rollers 43 includes a roller body 43a in a cylindrical shape and two axial members 43b that rotate together with the roller body 43a as one unit.

The axial members 43b have the same structure as the axial members 33b of the power supply rollers 33 in Embodiment 2, and thus each of the axial members 43b is provided with an axial projection 43c which projects outside from the roller body 43a along the axis of the roller body 43a. Each front surface of the axial projection 43c is in contact with the electrode member 37 by pressurizing. The alternating current is supplied to each electrode member 37 from the alternating current power 34.

The two power supply rollers 43 are arranged with a predetermined distance therebetween in the horizontal direction, and the fixing belt 31 is wound around approximately ½ of the outer circumferential surface of the roller body 43a of each power supply roller 43. Each roller body 43a is pressed against the whole part, in the width direction, of the inner circumferential surface of the resistance heating layer 31a which is the innermost layer of the fixing belt 31. One power supply roller 43 is arranged to face the pressing roller 32, and is pressed toward the pressing roller 32 so that the fixing belt 31 wound around the power supply roller 43 is pressed against the pressing roller 32. With this structure, the outer circumferential surface of the pressing roller 32 is dented.

In the fixing device 30 in Embodiment 3, areas moving in opposite directions of the resistance heating layer 31a between the two power supply rollers 43, of the fixing belt 31 moving in a circling motion, emit heat as the current flows between the roller body 43a of the power supply rollers 43. In this case, since each of the pair of power supply rollers 43 is arranged along the width direction of the resistance heating layer 31a, the whole current supplied to one power supply roller 43 along the width direction flows to the other power supply roller 43 along the circumferential direction of the resistance heating layer 31a. With this structure, the resistance heating layer 31a emits Joule heat that is approximately uniform over the whole part in the width direction in the area between the power supply rollers 43.

As the recording sheet S passes through the fixing nip N, the unfixed toner image on the recording sheet S is heated and pressed to be fixed onto the recording sheet S by the fixing belt 31 that has been heated approximately uniformly over the whole part in the width direction of the belt by the heating of the resistance heating layer 31a, and in addition the recording sheet S is pressed at both sides by the fixing belt 31 and the pressing roller 32 that are pressed against each other. The recording sheet S is heated approximately uniformly over the whole area thereof and the toner image is fixed onto the recording sheet S. As a result, there is no fear that an uneven toner image is fixed onto the recording sheet S, and a high-quality toner image can be obtained.

Also, since the fixing belt 31 is formed to be uniform over the whole part thereof, it can be used stably for a long time, with no fear that the fixing belt 31 is locally reduced in strength. Furthermore, the resistance heating layer 31a is provided on the inner circumferential surface side of the fixing belt 31, and the power supply rollers 43 are in contact with the inner circumferential surface of the resistance heating layer 31a. Therefore, there is no fear that toner or sheet powder having removed from the recording sheet is attached to the part where the resistance heating layer 31a is in contact with the power supply rollers 43, and there is no fear that a failure occurs in the power supply to the resistance heating layer 31a.

### Modifications

The image forming apparatus of the present invention is not limited to a tandem type color printer, but may be a printer for forming monochrome images. Also, the image forming apparatus is not limited to a printer, but may be a copier, a fax machine, an MFP (Multiple Function Peripheral) or the like that can form color or monochrome images.

### Summary of Embodiment

In the fixing device of the present invention described above, each of the power supply members is in contact with the resistance heating layer in an electrically conductive state along the direction perpendicular to the circumferential direction of the fixing belt. Thus the electric current supplied to one of the power supply members flows toward the other of the power supply members along the circumferential direction of the fixing belt. With this structure, it is possible to cause the resistance heating layer to emit heat approximately uniformly along the direction perpendicular to the circumferential direction of the fixing belt.

Also, since each of the power supply members is directly contacted with the resistance heating layer provided on the inner circumference side of the fixing belt, there is no need to remove part of the fixing belt so that each of the power supply members can be contacted with the resistance heating layer. With this structure, there is no fear that the stress locally concentrates on the heating belt even if a pressure is given to the fixing belt by the pressing member. As a result, the durability of the fixing belt is improved.

Furthermore, the resistance heating layer is provided on the inner circumference side of the fixing belt. With this structure, there is no fear that sheet powder or the like is attached to the power supply portion between the resistance heating layer and each power supply member. This enables power to be supplied stably to the resistance heating layer.

The present invention is useful as a technology for improving the quality of toner images that are fixed on recording sheets by using the resistance heating layer that emits heat as the current flows.

In the above fixing device, the pair of power supply members may be in contact with the resistance heating layer at least over a range through which the recording sheet passes.

In the above fixing device, each of the pair of power supply members may be a power supply roller pressed against the inner circumferential surface of the fixing belt so that the fixing belt is pressed against the pressing member.

In the above fixing device, the pair of power supply members may be power supply rollers around which the fixing belt is wound.

In the above fixing device, one of the power supply rollers may be arranged to face the pressing member with the fixing belt therebetween to press the fixing belt against the pressing member.

In the above fixing device, the fixing belt may be wound around the pair of power supply rollers and a pressing contact roller which is arranged to face the pressing roller with the fixing belt therebetween so that the fixing belt is pressed against the pressing roller.

In the above fixing device, the resistance heating layer may be made of an insulation material in which an electrically conductive filler is dispersed uniformly so that the resistance heating layer has a predetermined electric resistivity.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A fixing device for fixing a toner image onto a recording sheet, the fixing device comprising:
a fixing belt including, on an inner circumference side thereof, a resistance heating layer, extending over entire circumference of the fixing belt, operable to emit heat upon flowing of an electric current therethrough;
a pressing member operable to press an outer circumference of the fixing belt to form a fixing nip therebetween so that, while the recording sheet passes through the fixing nip, the toner image is fixed onto the recording sheet; and
a pair of power supply members arranged inside the fixing belt along the circumferential direction with a predetermined distance therebetween, the power supply members being in contact with the inner circumferential surface of the resistance heating layer in an electrically conductive state along a direction perpendicular to the circumferential direction.

2. The fixing device of claim 1, wherein
the pair of power supply members are in contact with the resistance heating layer at least over a range through which the recording sheet passes.

3. The fixing device of claim 1, wherein
each of the pair of power supply members is a power supply roller pressed against the inner circumferential surface of the fixing belt so that the fixing belt is pressed against the pressing member.

4. The fixing device of claim 1, wherein
the pair of power supply members are power supply rollers around which the fixing belt is wound.

5. The fixing device of claim 4, wherein
one of the power supply rollers is arranged to face the pressing member with the fixing belt therebetween to press the fixing belt against the pressing member.

6. The fixing device of claim 4, wherein
the fixing belt is wound around the pair of power supply rollers and a pressing contact roller which is arranged to face the pressing roller with the fixing belt therebetween so that the fixing belt is pressed against the pressing roller.

7. The fixing device of claim 1, wherein
the resistance heating layer is made of an insulation material in which an electrically conductive filler is dispersed uniformly so that the resistance heating layer has a predetermined electric resistivity.

8. An image forming apparatus comprising a fixing device for fixing a toner image onto a recording sheet, the fixing device including:
a fixing belt including, on an inner circumference side thereof, a resistance heating layer, extending over entire circumference of the fixing belt, operable to emit heat upon flowing of an electric current therethrough;
a pressing member operable to press an outer circumference of the fixing belt to form a fixing nip therebetween so that, while the recording sheet passes through the fixing nip, the toner image is fixed onto the recording sheet; and
a pair of power supply members arranged inside the fixing belt along the circumferential direction with a predetermined distance therebetween, the power supply members being in contact with the inner circumferential surface of the resistance heating layer in an electrically conductive state along a direction perpendicular to the circumferential direction.
